(19) United States
(12) Patent Application Publication
(10) Pub. No.: US 2004/0099049 A1
(43) Pub. Date: May 27, 2004

(54) Rheometer

(75) Inventor: Wolfgang Platzek, Karlsruhe (DE)

Correspondence Address: Lichti, Lempert, & Lasch, Bergwaldstr. 1, Karlsruhe, D-76227, DE

(73) Assignee: Thermo Electron (Karlsruhe) GmbH, Karlsruhe (DE)

(21) Appl. No.: 10/700,531

(22) Filed: Nov. 5, 2003

(30) Foreign Application Priority Data
Nov. 22, 2002 (DE) 102 54 502.2

(51) Int. Cl. G01N 11/14

(52) U.S. Cl. 73/54.28; 73/54.35

(57) ABSTRACT

A rheometer has an upper measuring part and a lower measuring part, between which a measuring chamber is formed for receiving a sample of a substance to be examined. The two measuring parts can be moved relative to each other and, in particular, be turned or pivoted, wherein the upper measuring part and/or the lower measuring part consist at least partially of ceramic material.

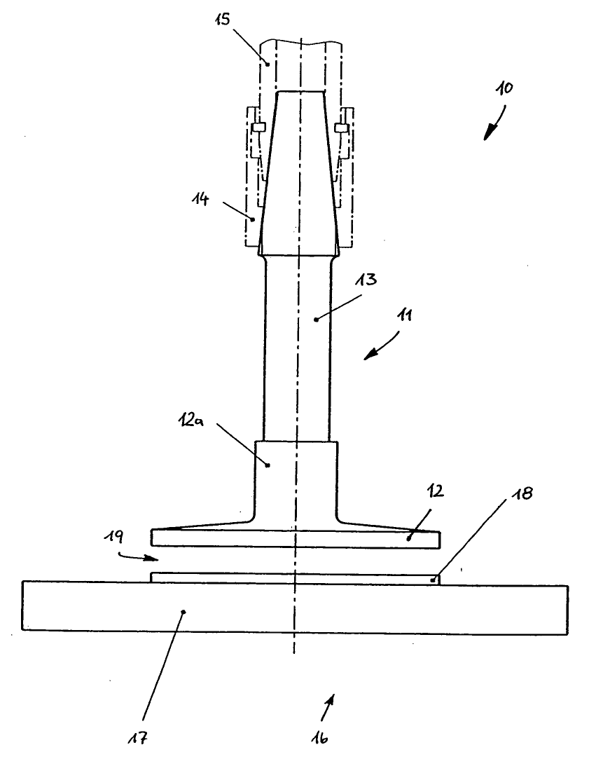

This application claims Paris Convention priority of DE 102 54 502.2 filed Nov. 22, 2002 the complete disclosure of which is hereby incorporated by reference.

### BACKGROUND OF THE INVENTION

The invention concerns a rheometer comprising an upper measuring part and a lower measuring part, between which a measuring chamber is formed for receiving a sample of a substance to be examined, wherein the two measuring parts can be moved relative to each other and, in particular, be turned or pivoted.

A rheometer is usually used to determine the characteristic rheological values of a viscous substance, wherein the rheometer may be an oscillation rheometer or an axial rheometer. An oscillation rheometer, on which the following example is based, usually comprises a lower stationary measuring part (stator) and an upper measuring part (rotor) which can be rotated or pivoted, between which a measuring chamber is formed to receive a sample of the substance to be examined. The forces and tensions produced through relative adjustment between the upper and lower measuring parts are determined from which the desired characteristic Theological values can be calculated. The characteristic rheological values determined in this fashion depend i.a. on the conditions of the surroundings during the measurement and also on the physical conditions of the rheometer, which influence the result of the experiment. Concerning the physical conditions of the rheometer, the geometry of the measuring parts which usually consist of metal, in particular titanium or aluminium, determine the dynamics of the rheometer and must be taken into consideration. The inertial mass of the moved measuring part is proportional to its size. Reduction in size of the moved measuring part is generally not possible, since it is standardized. The metal moreover has high thermal conductivity such that the thermodynamic behavior of the metallic measuring parts must be taken into consideration in the temperature control of the sample. Observing the mentioned physical properties of the measuring parts for determining the characteristic rheological values is demanding and susceptible to errors. For this reason, modern rheological measuring technology seems to have reached its physical limits.

It is the underlying purpose of the present invention to produce a rheometer of the above-mentioned type which allows increased measuring accuracy.

### SUMMARY OF THE INVENTION

This object is achieved in accordance with a rheometer of this type in that the upper measuring part and/or the lower measuring part consist at least partially of ceramic material.

The use of ceramic as a material for the measuring parts has the advantage that the measuring parts have a very high wear resistance and at the same time a low inertial mass, wherein the physical properties of the measuring parts, e.g. the thermal conductivity, the coefficient of expansion, the modulus of elasticity, and the bending and torsion resistance, can be determined with high accuracy and are to be correspondingly taken into consideration for calculation of the characteristic rheological values. Moreover, the ceramic measuring parts can be produced in an inexpensive fashion.

The upper and/or lower measuring part may be conical, cylindrical, plate-shaped, propeller-like or have any other geometrical measuring shape. The upper measuring part may comprise e.g. a plate or a cone which delimits the upper side of the measuring chamber and which is coupled to a driven shaft, wherein the plate or cone consists of ceramic material. The plate or cone may be held on the shaft in a replaceable fashion. For example, the plate or cone can be formed in one piece with a coupling sleeve, which can be connected to a coupling part that, in turn, can be fixed to the shaft. In a further development of the invention, the shaft and/or the coupling sleeve and/or the coupling part may also consist of ceramic material.

The lower measuring part preferably comprises a base plate which delimits the lower side of the measuring chamber and consists of ceramic material.

The use of ceramic material as structural material for the measuring parts facilitates production even of complicated shapes of the measuring parts e.g. by producing the ceramic components through injection molding.

In a further development, the ceramic components are surface-treated to increase the chemical or physical resistance to aggressive or abrasive media. The surface treatment may e.g. be surface coating, metallization, hardening or nitration. Formation of hard material layers, sliding layers or anti-adhesive layers further increases the wear resistance of the ceramic measuring parts. It is thereby also possible to adjust the surface properties and scratch resistance of the measuring parts to the substance to be measured or to the respective application, as is particularly important in for rheological measurements with simultaneous optical observation.

The characteristic rheological values depend i.a. on the temperature of the sample during the measurement. To obtain standardized characteristic rheological values, one tries to heat the sample to a predetermined temperature and maintain this temperature for the entire measurement. A further development of the invention provides that the temperature of the sample located in the measuring chamber can be controlled by a temperature control means and in particular by a microwave device, wherein the sample can be directly heated through microwaves without heating the ceramic measuring parts. Alternatively, the temperature of the sample located in the measuring chamber can be controlled through infrared radiation, wherein the energy absorption in the ceramic material can be kept low or at a desired level through selection of a suitable wavelength.

Further details and features of the invention can be extracted from the following description of an embodiment with reference to the drawing.

### BRIEF DESCRIPTION OF THE DRAWING

The single drawing shows a view onto a test assembly of a rheometer.

### DESCRIPTION OF THE PREFERRED EMBODIMENT

A rheometer 10 (shown only in sections in the figure) has an upper rotatable or pivotable measuring part (rotor) 11 which comprises a substantially horizontally oriented ceramic plate 12 whose upper side is integral with a coupling sleeve 12a. A shaft section 13 of a coupling part 14 can be inserted into the coupling sleeve 12a and the coupling part 14 can be coupled to a vertical, driven shaft 15. When the shaft 15 is turned or pivoted, the motion is transferred to the plate 12 via the coupling part 14.

A measuring chamber 19 is formed below the plate 12 in which a sample (not shown) of a substance to be examined can be disposed. The measuring chamber 19 is delimited at its lower side by a base plate 18 of ceramic material which is supported on a base part 17 fixed to a frame. The base part 17 and the base plate 18 form a lower measuring part 16.

The ceramic components i.e. the plate 12 with coupling sleeve 12a and the base plate 18 are each preferably held in an exchangeable fashion.

I claim:

1. A rheometer for examining a sample of a substance, the rheometer comprising:
an upper measuring part;
a lower measuring part, wherein said lower and said upper measuring part delimit a measuring chamber for receiving the sample; and
means for moving said upper measuring part relative to said lower measuring part, wherein at least one of said upper measuring part and said lower measuring part comprise a ceramic material.

2. The rheometer of claim 1, wherein said moving means effects a turning or pivoting motion.

3. The rheometer of claim 1, wherein said moving means comprises a driven shaft and said upper measuring part has a plate or a cone which delimits an upper side of said measuring chamber and which is coupled to said driven shaft, said plate or said cone consisting essentially of said ceramic material.

4. The rheometer of claim 3, wherein said upper measuring part comprises a coupling part and a coupling sleeve cooperating with said coupling part and integral with said plate or cone, wherein said coupling part cooperates with said driven shaft.

5. The rheometer of claim 1, wherein said lower measuring part has a ceramic base plate which delimits a lower side of said measuring chamber.

6. The rheometer of claim 1, wherein ceramic components are produced by an injection molding method.

7. The rheometer of claim 1, wherein ceramic components are surface-treated.

8. The rheometer of claim 1, wherein a temperature of the sample located in said measuring chamber can be controlled by a microwave device.

9. The rheometer of claim 1, wherein a temperature of the sample located in said measuring chamber can be controlled through infrared radiation.
